(19) United States
(12) Patent Application Publication
(10) Pub. No.: US 2021/0395043 A1
(43) Pub. Date: Dec. 23, 2021

(54) ELEVATOR

(71) Applicant: Inventio AG, Hergiswil (CH)

(72) Inventor: Nilesh Hagawane, Pune Maharashtra (IN)

(21) Appl. No.: 17/309,243

(22) PCT Filed: Dec. 18, 2019
(86) PCT No.: PCT/EP2019/085987

§ 371 Date: May 11, 2021

(30) Foreign Application Priority Data
Dec. 18, 2018 (EP) 18213255.5

(51) Int. Cl. B66B 11/02; B66B 5/00

(52) U.S. Cl. CPC B66B 11/024; B66B 5/0018; B66B 11/0246

(57) ABSTRACT

An elevator car has a roof hatch arranged on a car roof and a ventilation device mounted on the roof hatch, wherein the car roof has a car top surface defining a walkable region. The roof hatch has a cover plate on which a fan of the ventilation device is mounted, wherein the cover plate, at least when the roof hatch is in a normal position, is an integral part of the walkable region. The roof hatch is stored on an exit opening in the car roof whereas the roof hatch can be removed and put aside to the car top surface. The cover plate has a central aperture through which the air blown by the fan can flow. The aperture is secured and covered by a grill mounted on the cover plate, whereas the grill is dimensioned to provide the grill with a walk-on capability.

### FIELD

The invention relates to an elevator car.

### BACKGROUND

Elevator systems comprise elevator cars which can move up and down in an elevator shaft with suspension means, for example, in the form of suspension cables or suspension straps, by means of a drive unit. In the case of an elevator malfunction, for example, it may be necessary to evacuate passengers from the car. If it should not be possible to move the car to a floor and to open its doors there, it may be necessary to take measures so that the passengers in the car can leave the car via the car roof. For this purpose, provisions can be made for a roof hatch, through which the persons in the elevator car can get to the roof of the elevator car. Further, for an agreeable climate inside the car and for the passenger comfort, many elevator cars nowadays comprise ventilation devices mounted on the roof of the car.

### SUMMARY

It is a task of the present invention to provide an improved elevator car having a roof hatch and a ventilation device. The car top surface shall have a sufficiently large walkable region.

According to the invention, the elevator car comprises a roof hatch arranged on a car roof and a ventilation device mounted on the roof hatch. The car roof has a car top surface defining a walkable region. The roof hatch has a cover plate on which a fan of the ventilation device is mounted. The cover plate, at least when the roof hatch is in a normal position, is an integral part of the walkable region. The cover plate being an integral part of the walkable region means that the cover plate is designed in such a way that it has walk-on capability. The car roof space utilized in an optimum manner without having loss of ride comfort with respect to the room climate and safety. The car roof can be easily walked on for the propose of maintenance. The car top surface has a sufficient walkable or standing area for maintenance personal in order to be able to offer a sufficiently large work area for maintenance or inspection. The previously mentioned normal position is the position when the roof hatch is closed.

The roof hatch may be used as an emergency exit hatch in case of an elevator malfunction to evacuate persons from inside the elevator car. However, it is also considerable to use the roof hatch to provide access for maintenance persons to the elevator car roof.

Preferably, the cover plate of the roof hatch lies, when the roof hatch is in a normal position, within or below the car top surface. When the cover plate lies within the car top surface, the over plate may sit flush with the neighboring the car top surface. So, the car top surface and the cover plate are on the same level. When the cover plate lies below the car top surface, a horizontal top surface of the cover plate is recessed with respect to the car top surface in a vertical direction. Thus, the cover plate extends essentially in an approximately plane-parallel manner in relation to the car top surface. The cover plate, when in the normal position, may be arranged at a distance of between 2 to 10 cm, preferably between 2 to 8 cm, particularly preferably at between 3 to 5 cm below the car top surface.

The roof hatch may be pivotally attached to or slidingly mounted on the car roof. However, it may be advantageous if the roof hatch rests on an exit opening in the car roof whereas the roof hatch can be removed and put aside to the car top surface. Such an arrangement is cost-effective and easy to handle. The roof hatch may have a weight of 10 kg and preferably 5 kg or less. Such a light roof hatch with integrated ventilation device can be particularly easily removed or pivoted.

In a preferred embodiment, the cover plate defines a bottom portion of a cover structure having a tray-like configuration enclosed by a peripheral portion. The tray allows a lower insertion of the fan and thus protruding associated components such as the motor of the fan can be at least partially immersed.

The peripheral portion may comprise a horizontal edge portion which rests flat on the car top surface. The edge portion may be formed by a step in a sheet metal for forming the cover structure.

The cover plate may have a central and preferably circular aperture through which the air blown by the fan can flow. Preferably, the aperture is secured and covered by a grill mounted on the cover plate. In an especially preferred embodiment, the grill is dimensioned in such a way that the grill has a walk-on capability. The grill and the cover plate may be arranged on the same level. Particularly preferably, the car top surface, the cover plate as well as the grill may extend essentially in an approximately same horizontal plane in order to get an advantageous maximized walkable area on the car roof.

Said grill can comprise a plurality of annular webs and radial webs. The annular webs may extend concentrically at the radial distance to one another having a mutual distance of approximately 1 to 5 cm. The radial webs may be distributed in a circumferential direction, wherein radial webs connect the annular webs to one another.

The ventilation device might be a radial fan or a cross-flow fan. A simple and cost-effective ventilation can be provided, when the ventilation device is or comprises an axial-flow fan which is driven by an electric motor. The grill may have a central installation opening for said motor. The installation opening may be surrounded by a ring for holding the motor of the fan.

The motor for driving the fan can be positioned above the grill and the fan may further comprise a plurality of blades which are positioned below the grill. The plates may extend readily outwardly from a hub and arranged about a vertical central axis. The motor may comprise a height of about 30 cm or less.

### DESCRIPTION OF THE DRAWINGS

Further individual features and advantages of the invention are derived from the following description of exemplary embodiments and from the drawings in which:

FIG. 1 is a schematic side view of an elevator system comprising an elevator car with a ventilation device on a car roof,

FIG. 2 is a schematic side view of an elevator car comprising a roof hatch with a ventilation device according to the present invention,

FIG. 3 shows the elevator car of FIG. 2 after removing of the roof hatch,

FIG. 4 is a perspective view of a car roof with a roof hatch having an integrated ventilation device, and

FIG. 5 shows the roof hatch as from FIG. 4 in a slightly modified version.

### DETAILED DESCRIPTION

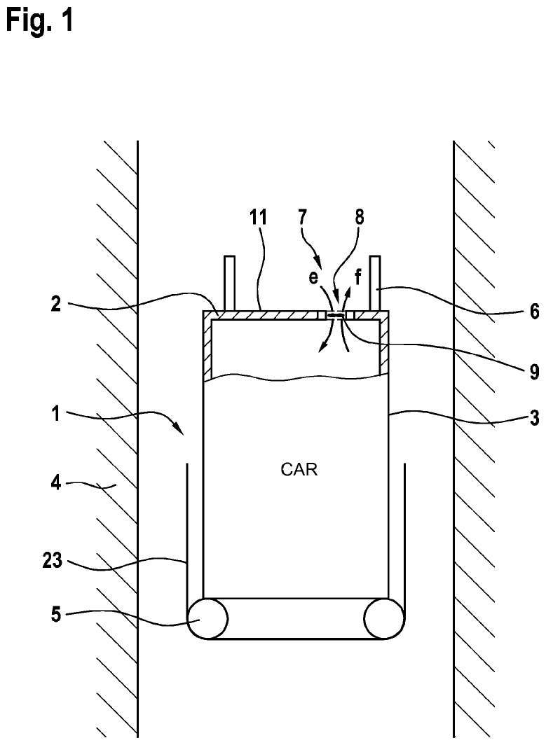

An elevator system consists, as illustrated in FIG. 1 by way of example, of an elevator car 1 which is arranged in an elevator shaft 4 to be movable along a substantially vertical axis. The elevator car 1 serves primarily for the movement of persons and/or goods. The elevator car 1 is, in the illustrated example, connected with a counterweight (not shown) by suspension means 23. The suspension means 23 suspend the car 1 in the form of an under-looping in a 2:1 suspension and the suspension means 23 are looped around the car 1 by means of guide rollers 5. The elevator car 1 comprises a car floor, sidewalls 3, a front wall containing a car entrance, a back wall and a car roof 2.

The car roof 2 can be walked on for the performance of maintenance work or for inspection runs. The car top surface defining the walkable region which lies within the balustrade 6 is denoted by 11.

On the car roof 2, a ventilation device 8 having a fan 9 is arranged. Depending on the desired ventilation, an air flow can be produced into or out from the car 1 (see arrows e, f). The ventilation device 8 is integrated in a roof hatch 7 which can be released and which, after releasing, leaves an exit opening through which passengers can be evacuated. For the evacuation, a ladder (not shown) can be used, which is by way of example, stored in or at the sidewall of the elevator car 1.

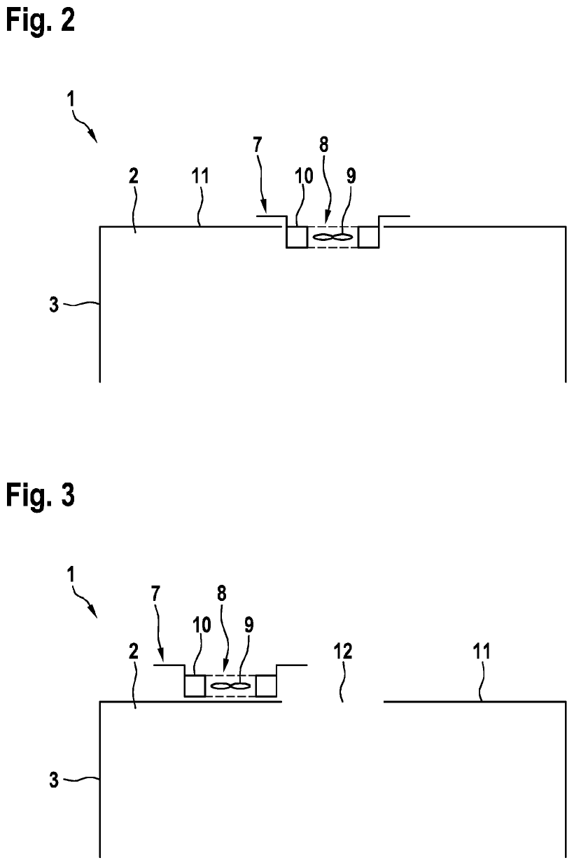

FIG. 2 shows an elevator car 1 comprising a roof hatch 7 arranged on the car roof 2. In the normal position as shown in FIG. 2, the whole area of the car top surface 11 is a walkable region. The roof hatch 7 in which the fan 9 of the ventilation device 8 is integrated covers an opening in such a way that the whole area on the car top surface 11 can be used by a person doing maintenance works.

The roof hatch 7 has a cover plate 10 which lies within the car top surface 11. The roof hatch 7 is stored on the exit opening and can be removed and put aside to the car top surface 11. The respective removed position is shown in FIG. 3. In FIG. 3 the open exit opening in the car roof 2 is denoted by 12.

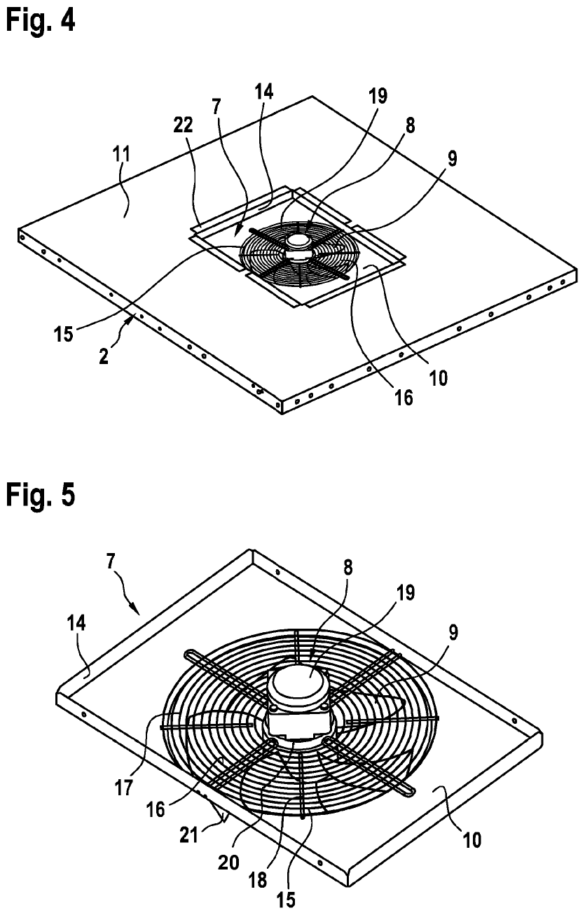

Constructional features of the car roof 2 of the inventive car 1 are shown in FIG. 4. The cover plate 10 of the roof hatch 7 defines a bottom portion of a cover structure having a tray-like configuration. This bottom portion is enclosed by a peripheral portion 14. The peripheral portion 14 comprises a horizontal edge portion 22 which is formed by a step in the sheet metal for forming the cover structure. The horizontal edge portion 22 rests flat on the car top surface 11. In the normal or rest position as shown in FIG. 4 the cover plate 10 lies slightly below the car top surface 11.

The cover plate 10 has a central circular aperture 15 through which the air blown by the fan 9 can flow. The fan 9 is an axial-flow fan which is driven by an electric motor 19. The aperture 15 is secured and covered by a grill 16 mounted on the cover plate 10. For a particularly large work area for maintenance or inspection on the car roof 2 it is preferred that the grill 16 is dimensioned in such a way that the grill 16 has a walk-on capability.

FIG. 5 shows a modified roof hatch 7 which has compared to the one as from FIG. 4 no horizontal edge portions. For such a roof hatch 7, the car roof may comprise a fitting arrangement (not shown) on which the roof hatch can be placed. The fitting arrangement, for example, may comprise a stop bar arranged at the edge region of the exit opening in the car roof. This stop bar forms a mounting frame on which the roof hatch can be inserted and placed.

The present axial-flow fan 9 comprises a plurality of blades 21. The blades 21 which are arranged about a vertical central axis extend radially outwardly from a hub. The motor 19 for driving the fan 9 is positioned above the grill 16. The blades 21 of the fan 9 are positioned below the grill 16. The motor 19 has a compact design and a height of about 30 cm or less. The roof hatch 7 preferably has a weight of 10 kg or less so that the roof hatch can be easily removed without any special effort.

Furthermore, as from FIG. 5 it can be seen that the grill 16 comprise a plurality of annular webs 17 and radial webs 18. The annular webs 17 extend concentrically at a radial distance to one another having a mutual distance of approximately 1 to 5 cm. The radial webs 18 are distributed in the circumferential direction, whereas the radial webs 18 connect the annular webs 17 to one another. The grill 16 has a central installation opening 20 for the installation and mounting of the motor 19.

The roof hatch 7 can be mechanically coupled to a switch or sensor (not shown) for monitoring the normal position of the roof hatch 7. This switch is connected to the elevator controller (not shown). In the case that the roof hatch 7 is wrongfully opened or manipulated when the elevator car moves, for safety reasons thanks to the switch it can be ensured that the car instantly stops.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. An elevator car comprising:
a car roof;
a roof hatch arranged on the car roof;
a ventilation device mounted on the roof hatch, the roof hatch having a cover plate on which a fan of the ventilation device is mounted;
wherein the car roof has a car top surface forming a walkable region; and
where the cover plate, at least when the roof hatch is closed in a normal position, is included as an integral part of the walkable region.

14. The elevator car according to claim 13 wherein the cover plate lies within or below the car top surface.

15. The elevator car according to claim 13 wherein the roof hatch is stored on an exit opening in the car roof and the roof hatch is adapted be removed from the exit opening and put aside on the car top surface.

16. The elevator car according to claim 13 wherein the cover plate forms a bottom portion of a cover structure having a tray-like configuration enclosed by a peripheral portion.

17. The elevator car according to claim 16 wherein the peripheral portion includes a horizontal edge portion formed by a step and resting flat on the car top surface.

18. The elevator car according to claim 13 wherein the cover plate includes a central aperture formed therein through which the air blown by the fan flows.

19. The elevator car according to claim 18 wherein the central aperture is secured and covered by a grill mounted on the cover plate.

20. The elevator car according to claim 19 wherein the grill dimensioned to provide a walk-on capability.

21. The elevator car claim 19 wherein the grill includes a plurality of annular webs connected to a plurality of radial webs.

22. The elevator car according to claim 19 wherein the fan is an axial-flow fan that is driven by an electric motor and the grill has a central installation opening formed therein at which the electric motor is positioned.

23. The elevator car according to claim 22 wherein the electric motor is positioned above the grill and the fan has a plurality of blades, the blades being positioned below the grill.

24. The elevator car according to claim 13 wherein the roof hatch is adapted to be mechanically coupled to a switch or sensor for monitoring the normal position of the roof hatch.
